(19) United States
(12) Patent Application Publication
(10) Pub. No.: US 2008/0297997 A1
(43) Pub. Date: Dec. 4, 2008

(54) Display apparatus and system for sporting and entertainment venues

(76) Inventors: Stephen Matthew Anderson, Milton (CA); Darrell Alan Parsons, Georgetown (CA)

Correspondence Address: Ralph A. Dowell of DOWELL & DOWELL P.C., 2111 Eisenhower Ave, Suite 406, Alexandria, VA, 22314, US

(21) Appl. No.: 11/806,443

(22) Filed: May 31, 2007

(51) Int. Cl. H05K 5/00; F16M 13/00; G06F 15/16; G06Q 40/00; G06Q 90/00

(52) U.S. Cl. 361/681; 248/200; 705/39; 709/217

(57) ABSTRACT

A display apparatus for mounting to a back surface of a seating structure consisting of a housing formed with a rear wall for mounting to the back surface of the seating structure, a pair of side walls extending from the rear wall to a front wall, and a top wall formed with a transparent portion. The display apparatus further consisting of a display screen positioned interiorly of the housing adjacent to the top wall, the display screen displaying one or more visual images viewable through the transparent portion of the top wall of the housing, and a computer unit positioned interiorly of the housing and operatively connected to the display screen for generating the one or more visual images. Preferably, the top wall and display screen of the display apparatus are disposed at a predetermined angle of inclination to the horizontal so as to ensure that the display screen is readily viewable by a spectator.

### FIELD OF THE INVENTION

The invention relates generally to a display apparatus and system for displaying one or more video images to a spectator at a sporting or entertainment venue, and more particularly to a display apparatus and system mounted to a seating structure at the sporting or entertainment venue for displaying one or more visual images that are readily viewable by a spectator.

### BACKGROUND OF THE INVENTION

Sporting and entertainment events generate considerable revenues for venue operators. As the costs associated with promoting and organizing events in large sporting and entertainment venues, such as stadiums, arenas, auditoriums and theaters, increase, venue operators may have to pass along the costs to spectators in the form of higher ticket prices. Many venue operators have undertaken significant modifications to their venues to increase the number of rows of seating structures. Other venue operators have opted to build entirely new venues consisting of a plurality of rows of tiered seating structures emanating from the performance area of the sporting or entertainment event, such as the playing field or stage. While both of these approaches can result in increased seating capacity and potentially higher revenues, the confined seating conditions and poor sightlines in these modified facilities have acted to decrease spectator satisfaction. As a result, many spectators have opted to enjoy live sporting and entertainment events from their home or a local tavern via live television or satellite broadcasts.

In addition to the considerable cost savings and greater comfort associated with watching an event from home or a local tavern, spectators have also become accustomed to receiving background information and commentary from television broadcasters which enhances their understanding and enjoyment of the subject sporting or entertainment event. Commonly television broadcasts of live sporting and entertainment events will include interactive participant statistics, historical information, trivia, contests and/or song lists, for example. Upon the occurrence of a significant activity in a sporting or entertainment event, the at-home spectator is presented with a variety of visual images replaying the activity and commentary illustrating the significance of the activity upon the outcome of the sporting or entertainment event.

Moreover, many taverns have installed interactive game devices consisting of sports, entertainment and/or general knowledge trivia games which patrons can enjoy while viewing live sporting or entertainment events. These interactive game devices provide patrons with a means for engaging with the other patrons in the tavern, as well as indirectly participating in the activities of the sporting or entertainment event.

Despite these advantages, many at-home spectators miss the excitement, spontaneity and camaraderie of attending live sporting and entertainment events with thousands of other spectators. In order to encourage these at-home spectators to attend live events, many venue operators have installed large display screens to provide periodic information to spectators relating to the activities of the sporting or entertainment event. These display screens are also utilized to encourage spectators to applaud and cheer throughout the course of the sporting or entertainment event. Cheer squads are also frequently provided at sporting events to increase the excitement level and the applause generated by the spectators. Concessions provided at sporting and entertainment events have also improved in recent years as spectators and their families have become increasingly more concerned about their diets. Despite these improvements, many venue operators are discovering that the modifications to the seating arrangements in most venues do not allow all spectators to readily view the display screen or otherwise feel connected to the activities on the playing field or stage, for example. Moreover, the concession areas in most venues are not adequately sized to handle the volume of spectators purchasing concessions throughout the course of the sporting or entertainment event. As a result, spectators often spend a considerable amount of time in line-ups waiting to purchase concessions, missing potentially important activities in the sporting or entertainment event.

The provision of a display system and a display apparatus mounted to the seating structures throughout the venue has until now generally been ignored since spectators have become accustomed to merely observing the activities of the participants on the playing field or stage. Such a display apparatus would enable a spectator to follow the activities of the sporting or entertainment event more closely, thereby increasing the satisfaction level of each of the spectators attending these events. As well, spectators seated at sporting and entertainment events offer an attractive opportunity for venue operators to generate additional revenue by displaying visual images, including advertisements and other promotional information.

Accordingly, there is a need for a display apparatus that is mounted to seating structures for displaying one or more visual images that are readily viewable by spectators seated throughout a sporting or entertainment venue. Moreover, there is a further need for a display apparatus which is adapted to provide a wide variety of information of interest to spectators, including the option to purchase concessions and beverages from the comfort of their seat and to participate in various entertainment activities using the display apparatus. Moreover, there is a further need for a display system for controlling the one or more visual images displayed to a plurality of spectators seated throughout the sporting or entertainment venue.

### SUMMARY OF THE INVENTION

The subject invention is directed to a display apparatus for mounting to a back surface of a seating structure consisting of a housing, a display screen positioned interiorly of the housing, and a computer unit positioned interiorly of the housing and operatively connected to the display screen for generating one or more visual images. The housing is formed with a rear wall for mounting to the back surface of the seating structure, a pair of side walls extending from the rear wall to a front wall, and a top wall formed with a transparent portion. The display screen is positioned adjacent to the top wall of the housing for displaying one or more visual images viewable through the transparent portion of the top wall of the housing. The display apparatus may further include a central processing unit for communicating the one or more visual images to the computer unit. The central processing unit is adapted to control the one or more visual images generated by the computer unit and displayed on the display screen.

The top wall and display screen are disposed at a predetermined angle of inclination to the horizontal. The predetermined angle of inclination of the display screen is adapted to direct the one or more visual images thereon towards a spectator seated adjacent to the display apparatus. By this design, the one or more visual images on the display screen of the display apparatus are directed upwardly to be readily viewable to a spectator in a seated position.

According to the present invention, the housing of the display apparatus includes a cover portion and a body portion coupled to the cover portion, whereby the cover portion and the body portion define the rear wall, the pair of side walls and the front wall, and the cover portion defines the top wall. In use, the coupling of the cover portion with the body portion forms an environmentally sealed interior space. The cover portion is releasably secured to the body portion using a lock. The housing may be fabricated from a material similar in appearance, color and texture to the material covering the back surface of the seating structure on which the display apparatus is mounted.

The one or more visual images displayed on the display screen of the present invention are adapted to provide a menu of one or more selections selected from the class of entertainment selections, promotional selections, audio and video selections, concession and beverage selections, assistance selections, spectator participation selections including interactive spectator trivia, voting and prediction selections, display of real-time statistics and information offered to a spectator. In order to enable the spectator to purchase one or more of the selections displayed on the display screen, the top or side wall of the housing may include a credit card reader coupled to the computer unit and adapted to allow a spectator to input the spectator's credit card information. Similarly, the top or side wall of the housing may be provided with a debit card reader coupled to the computer unit and adapted to allow a spectator to input the spectator's debit card information for purchasing one or more of the selections

The subject invention is also directed to an entertainment display system consisting of at least one display apparatus adapted to communicate with a central processing unit via a computer network. The central processing unit is adapted to communicate one or more visual images to the at least one display apparatus positioned on seating structures throughout the sporting and entertainment venue. The central processing unit may be adapted to control the one or more visual images generated by the computer unit and displayed on the display screens, based on the one or more inputs received from the one or more display apparatuses.

### BRIEF DESCRIPTION OF THE DRAWINGS

For a better understanding of the present invention, and to show more clearly how it may be carried out in practice, reference will now be made, by way of example only, to the accompanying drawings, in which:

FIG. 1 is a perspective view of a display apparatus made in accordance with a preferred embodiment of the invention, shown mounted to a back surface of a seating structure at a sporting and entertainment event;

FIG. 2 is a front plan view of the display apparatus shown in FIG. 1;

FIG. 3 is a cross-section view of the display apparatus shown in FIG. 2 along axis A-A;

FIG. 4 is an enlarged view of the section B-B shown in FIG. 3;

FIG. 5 is a perspective view of the display apparatus shown in FIG. 1 illustrating a spectator standing in an aisle adjacent to the display apparatus;

FIG. 6 is a perspective view of the display apparatus shown in FIG. 1 illustrating the line of sight from a spectator in a seated positioned to the display apparatus of the present invention;

FIG. 7 is a perspective view of the display apparatus shown in FIG. 1 illustrating use of the display apparatus as a foot rest by a spectator;

FIG. 8 is a perspective view of one embodiment of the display apparatus formed with a transparent touch panel and an access panel;

FIG. 9 is a perspective view of one embodiment of the display apparatus formed with one or more buttons;

FIG. 10 is a perspective view of one embodiment of the display apparatus formed with a credit card reader;

FIG. 11 is a perspective view of one embodiment of the display apparatus illustrating a display screen and a computer unit removed through a side wall of the display apparatus;

FIG. 12 is a perspective view of the display apparatus of the present invention mounted to a back surface of a seating structure using one or more fasteners;

FIG. 13 is a perspective view of a pair of mounting brackets for mounting the display apparatus to a back surface of a seating structure;

FIG. 14 is a perspective view of the display apparatus mounted to a seating structure using the mounting brackets shown in FIG. 13;

FIG. 15 is a perspective view of spacer for facilitating the mounting of the display apparatus of the present invention to a back surface of a seating structure;

FIG. 16 is a perspective view of the display apparatus of the present invention mounted to a back surface of a seating structure using the spacer of FIG. 15;

FIG. 17 is a schematic diagram of a computer unit of the display apparatus of the present invention;

FIG. 18 is a schematic diagram of a display system consisting of a plurality of display apparatuses in accordance with a preferred embodiment of the present invention;

FIG. 19 is a plan view of a display screen of the display apparatus in an exemplary embodiment of the present invention illustrating a main menu of selections;

FIG. 20 is a plan view of a display screen of the display apparatus in an exemplary embodiment of the present invention illustrating one or more entertainment selections;

FIG. 21 is a plan view of a display screen of the display apparatus in an exemplary embodiment of the present invention illustrating one or more concession and beverage selections;

FIG. 22 is a plan view of a display screen of the display apparatus in an exemplary embodiment of the present invention illustrating one or more interactive spectator participation selections;

FIG. 23 is a plan view of a display screen of the display apparatus in an exemplary embodiment of the present invention illustrating one or more interactive spectator participation selections consisting of one or more trivia selections;

FIG. 24 is a plan view of a display screen of the display apparatus in an exemplary embodiment of the present invention illustrating one or more interactive spectator participation selections consisting of one or more prediction games;

FIG. 25 is a plan view of a display screen of the display apparatus in an exemplary embodiment of the present invention illustrating one or more assistance selections; and

FIG. 26 is a plan view of a display screen of the display apparatus in an exemplary embodiment of the present invention illustrating one or more entertainment selections consisting of one or more video images.

### DETAILED DESCRIPTION OF THE INVENTION

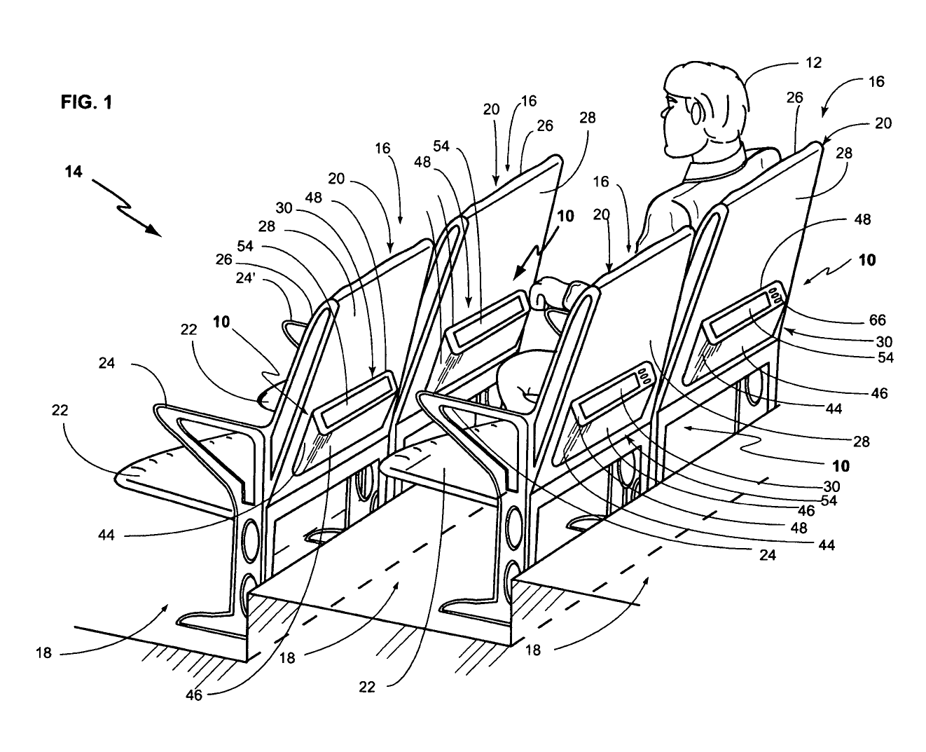

Reference is made to FIGS. 1, 2, 3, 5-7 and 18 which illustrate a display apparatus 10 and system 130 for displaying one or more visual images to a spectator during a sporting or entertainment event in accordance with a preferred embodiment of present invention. The display apparatus 10 of the present invention is particularly well adapted for use in sporting and entertainment venues, such as stadiums, arenas, auditoriums and theaters, having a plurality of seating structures 16 arranged in a series of alternating tiered aisles 18, as shown in FIG. 1. As is well known, most venues are provided with tiered aisles 18 of seating structures 16 to enable large numbers of spectators to attend sporting and entertainment events, such as, for example, football, basketball, baseball or hockey games, as well as concerts and operas. Each successive tiered row of seating structures 16 is commonly staggered or off-set to enhance a spectator's sightline to the activities of the sporting or entertainment event.

Typically, such seating structures 16 consist of a back rest member 20, a seat member 22 and a pair of opposed armrest members 24 and 24′. The back rest member 20 consists of a support surface 26 for supporting the spectator 12 in a seated position and a back surface 28 facing rearwardly of the seated spectator. As will be recognized by those skilled in the art, the seating structure 16 illustrated in FIG. 1 and the various parts comprising the same are meant to depict a general embodiment of such seating structures 16 and is not meant in anyway to limit the scope of the invention. It should be understood that the display apparatus 10 and system 130 of the present invention may also be used in association with bench seating structures and movable seating structures commonly found in gymnasium-type sporting and entertainment venues.

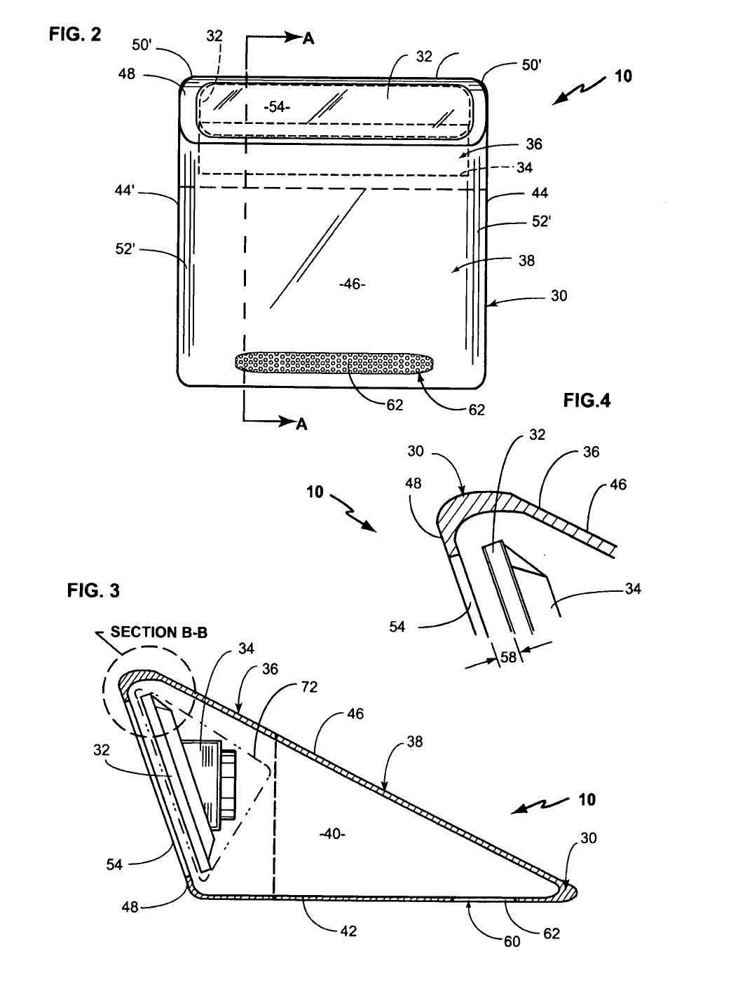

Referring to FIGS. 2, 3 and 4, the display apparatus 10 of the present invention consists of a housing 30 for mounting to the back surface 28 of the seating structure 16, a display screen 32 positioned interiorly of the housing 30 and a computer unit 34 positioned interiorly of the housing 30 and operatively connected to the display screen 32 for generating one or more visual images to be displayed to a spectator seated adjacent to and facing the display apparatus 10. Referring to FIGS. 2 and 3, the housing 30 includes a cover portion 36 and a body portion 38 which are coupled together to form an environmentally-sealed interior space 40. The environmentally-sealed interior space 40 protects the internal components of the display screen 32 and the computer unit 34 from external elements that may affect the proper operation of the display apparatus 10, such as water, dust and spilled concessions. The cover portion 36 is coupled to the body portion 38 and together define a rear wall 42, a pair of side walls 44 and 44′ extending from the rear wall 42 to a front wall 46, and a top wall 48 extending between the rear, front and side walls 42, 46, 44, and 44′, respectively.

While the housing 30 shown in FIGS. 2 and 3 has a generally wedge-shaped cross-sectional configuration, it should be understood that the housing 30 may have any suitable configuration. Referring to FIGS. 1 and 2, the housing 30 is dimensioned to fit across the back surface 28 of the seating structure 16 and has a slender cross-sectional configuration so as not to impede the movement of spectators along each of the tiered rows of seating structures 16 (such as the seating structures 16 shown in FIG. 5). Referring to FIGS. 2 and 3, the rear and front walls 42 and 46 join each of the side walls 44 and 44′ along a rounded rear wall 50 and 50′ and a rounded front wall 52 and 52′, respectively. By this design, a spectator moving along the tiered aisles 18 of seating structures 16 will be less likely to snag their clothing or clothing accessories on the housing 30. Moreover, the rounded rear and front walls 50, 50′, 52 and 52′, respectively, also provide a more aesthetic appearance to the display apparatus 10 and the venue as a whole.

Referring to FIGS. 2 and 3, the top wall 48 of the housing 30 includes a transparent portion 54 for enabling the external viewing of the display screen 32 and the touch screen operation of the display apparatus 10 by a spectator. The display screen 32 is positioned interiorly of the housing 30 adjacent to the top wall 48. The transparent portion 54 also protects the internal components of the display screen 32 and computer unit 34 positioned within the interior space 40 of the housing 30. The transparent portion 54 may be fabricated from clear plastic, glass, Plexiglas®, polycarbonate or any other suitable transparent material through which the display screen 32 is viewable by a spectator from outside of the housing 30.

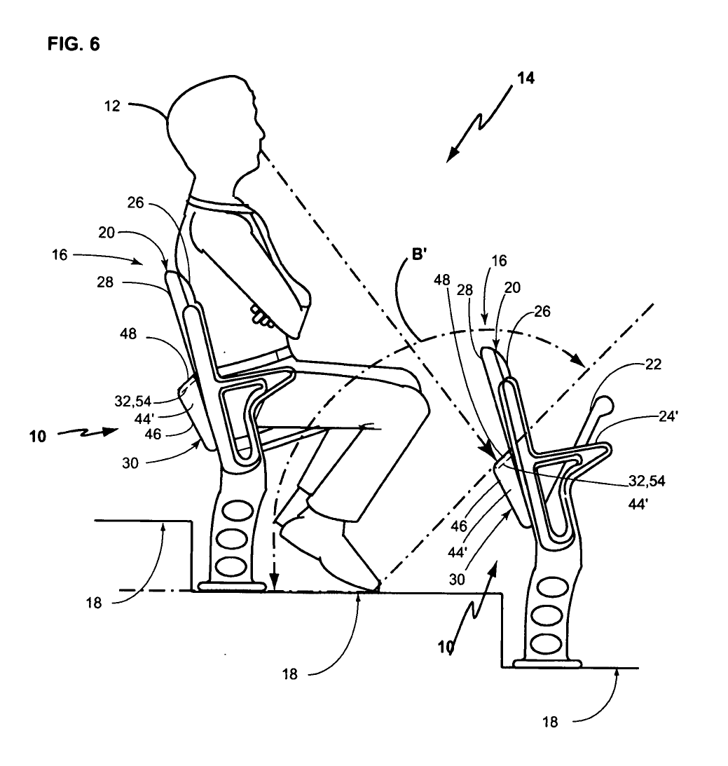

Referring to FIGS. 5 and 6, both the top wall 48 and display screen 32 of the display apparatus 10 are angled at a predetermined angle of inclination B′ to the horizontal so as to be readily viewable by a spectator seated in a seating structure 16 adjacent to and facing the display apparatus 10. In order to be adaptable for use with various seating structures and venues, the top wall 48 and display screen 32 may be angled at any suitable angle of inclination B′ to the horizontal from 0 to 180°. The angle of inclination B′ by which the top wall 48 and the display screen 32 are angled toward the spectator will depend upon the specific seating structures 16 at each sporting and entertainment venue, as well as the orientation of the tiered aisles 18 of seating structures 16. When determining the suitable angle of inclination B′ to the horizontal for a particular venue, it is also advantageous to also ensure that the display screen 32 is not appreciably obscured as a result of glare from sunlight or the lighting system (not shown) within the venue. It should be understood by those skilled in the art that the display screen 32 may be provided with a suitable adjustment to enable a spectator seated adjacent to the display apparatus 10 to make minor adjustments to the positioning of the displaying screen 32, and particularly the predetermined angle of inclination B′, to maximize the viewability of the one or more visual images on the display screen 32.

For best viewing by a spectator seated adjacent to and facing the display apparatus 10, the angle of inclination B′ to the horizontal is between 90° and 180°. By this design, a line of sight 56 from the spectator viewing the one or more visual images on the display apparatus 10 is generally perpendicular to the top wall 48 and display screen 32 of the display apparatus 10 (as shown in FIG. 6). Preferably, a spectator should be able to readily view the one or more visual images on the display screen 32 of the display apparatus 10 without having to lean forward or otherwise substantially adjust their seated position.

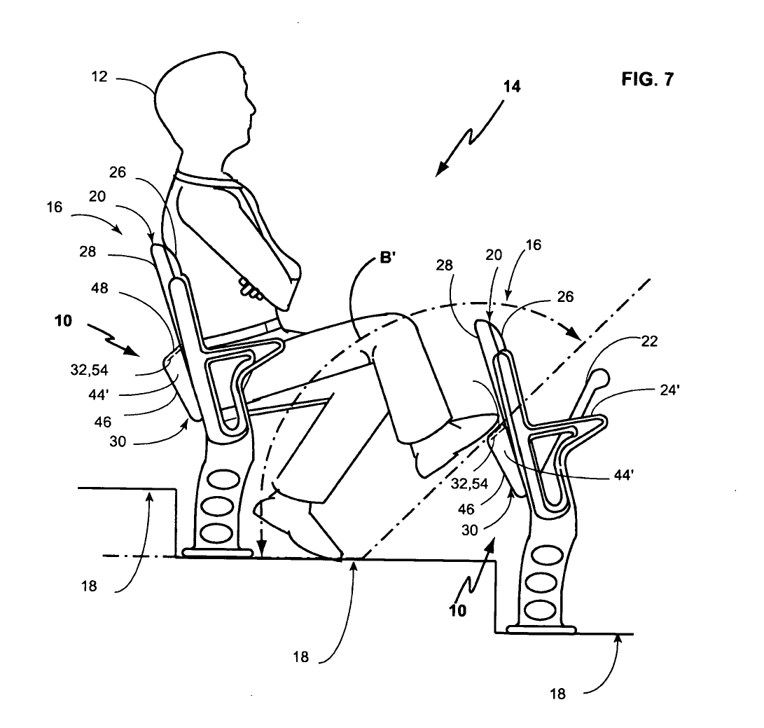

In view of the increasingly confined seating arrangements in most sporting and entertainment venues, the top wall 48 of the housing 30 is further adapted to provide a spectator seated adjacent to and facing the display apparatus 10 with a foot rest. As shown in FIG. 7, the angle of inclination B′ of the top wall 48 of the housing 30 presents a convenient and comfortable surface upon which the spectator may rest their foot during the sporting or entertainment event.

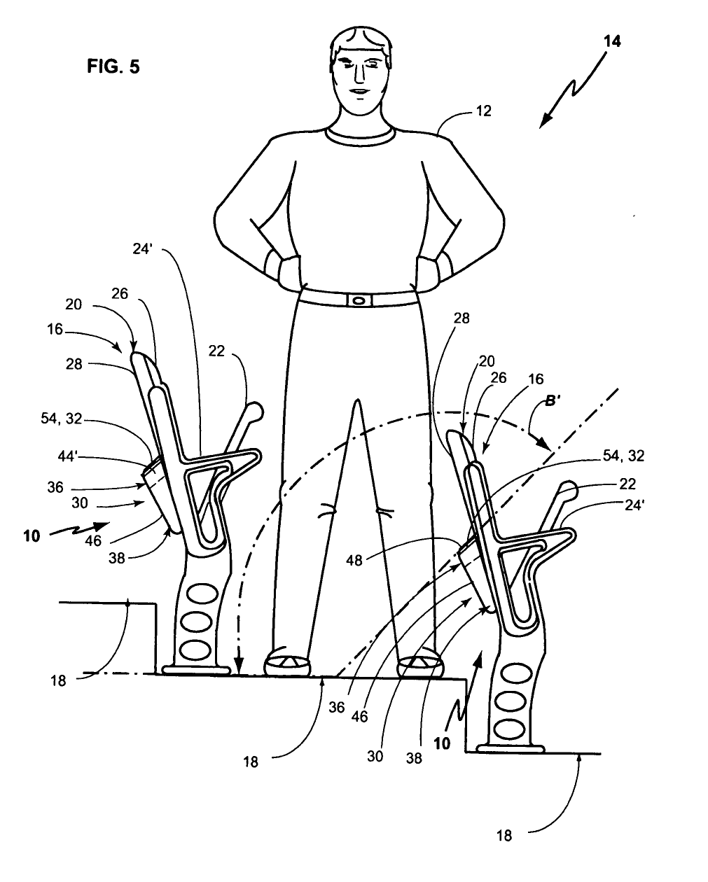

When the top wall 48 of the housing 30 is utilized as a foot rest, there arises the potential for damage to the underlying display screen 32. In order to minimize the repair and maintenance costs associated with such heavy use and vandalism, the display screen 32 may be spaced apart from the transparent cover 54 so that any damaging protrusion into or through the transparent cover 54 does not damage the underlying display screen 32 (as shown in FIGS. 3 and 4). Forming an air space 58 between the display screen 32 and the transparent cover 54 also allows air within the environmentally-sealed interior space 40 to circulate, thereby minimizing the likelihood of condensation obscuring the display screen 32.

The display screen 32 is preferably a liquid crystal display (LCD) adaptable for displaying one or more visual images, although any suitable display screen may be utilized with the display apparatus 10 of the present invention. The display screen 32 may also pass or block light in order to clearly display the one or more visual images for viewing by a spectator. When the display apparatus 10 is utilized in an outdoor venue, it may be desirable for the display screen 32 to be brighter than would otherwise be required in an indoor device due to light and glare created by sunlight or the venue lighting system. As increasing the brightness of the display screen 32 may generate more heat and cause the power utilized by the computer unit 34 to be greater, it may be necessary to provide a vent 60 for dissipating heat from within the environmentally-sealed housing 40 to the ambient environment (as shown in FIGS. 2 and 3). The vent 60 may include a vent aperture 62 adaptable to permit heat generated by the display screen 32 and/or computer unit 34 to dissipate outside of the housing 30. However, the present invention may utilize any suitable type of vent as known by those skilled in the art, such as, for example, fans or other means for providing forced convection of the air within the environmentally-sealed housing 30.

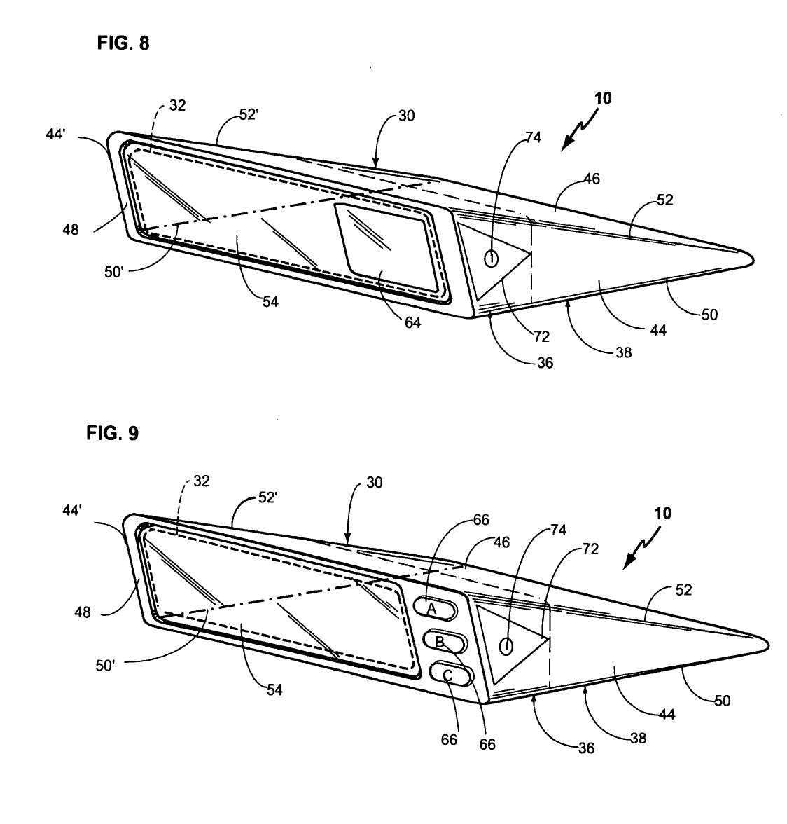

In an embodiment of the display apparatus 10 shown in FIG. 8, the display screen 32 is adaptable for receiving one or more inputs from a spectator using touch screen technology. The transparent portion 54 of the top wall 48 of the housing 30 may be provided with a transparent touch panel 64 which overlies the display screen 32 for receiving one or more inputs when touched by a spectator. The one or more inputs may be provided by the spectator in response to one or more visual images displayed on the display screen 32 of the display apparatus 10.

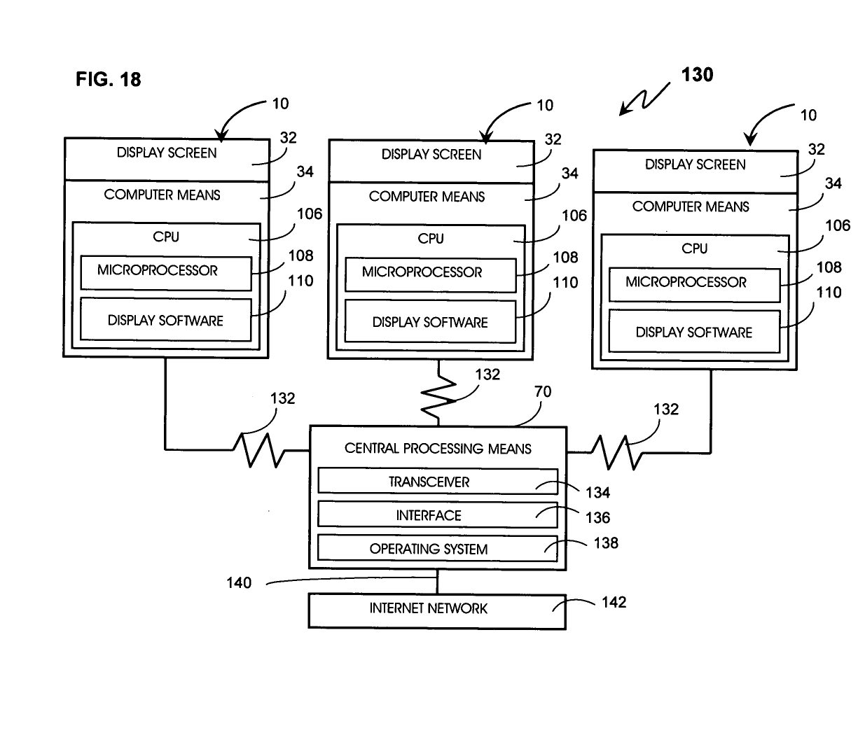

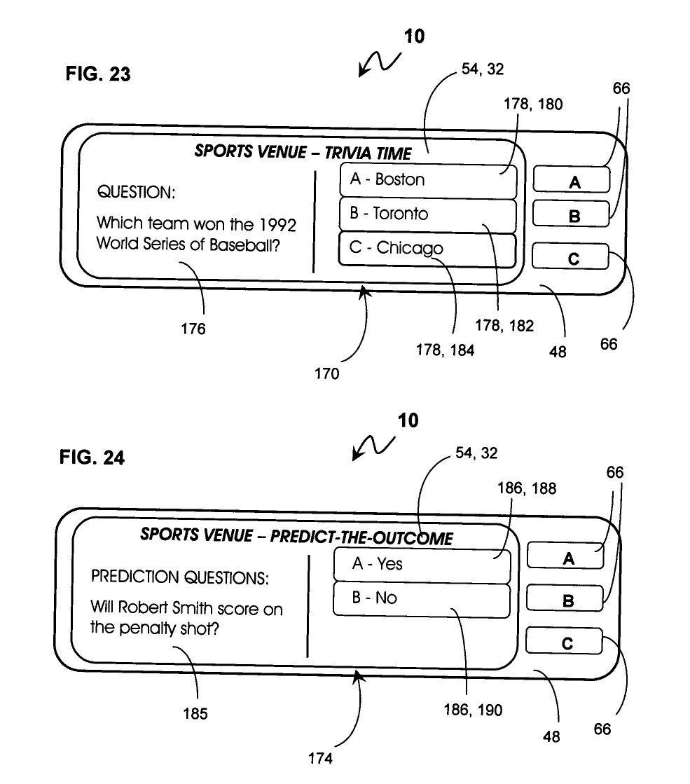

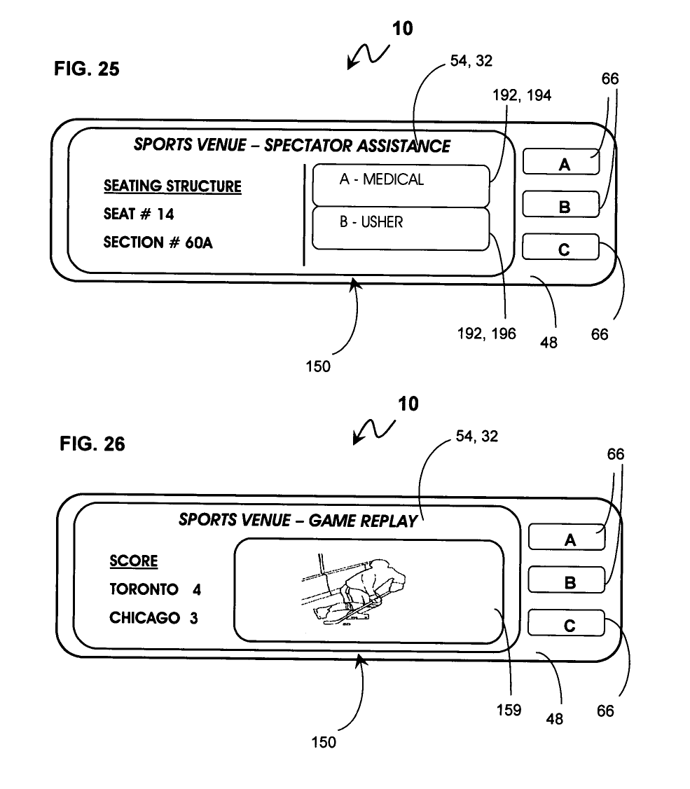

In an embodiment of the display apparatus 10 shown in FIG. 9, the one or more inputs from a spectator may be inputted using one or more buttons 66 provided on the top or side wall 48 and 44 of the housing 30 adjacent to the transparent cover 54 and the display screen 32. The function of the one or more input buttons 66 is configured to correspond to the one or more visual images being displayed on the display screen 32. As will be discussed with reference to FIG. 23, if a trivia question and three possible answers (for example “A”, “B” and “C”) are presented to the spectator on the display apparatus 10, the spectator may press the one or more buttons 66 corresponding to their desired answer to respond to the one or more visual images. The one or more buttons 66 may also be configured to enable a spectator to scroll up and scroll down through a menu of one or more selections to be described with reference to FIGS. 18-26. Moreover, the one or more buttons 66 may also be configured to initiate an assistance button 74 on the display screen 32 for displaying a wide variety of helpful information or hints, for example, to the spectator, as will be described with reference to FIG. 25.

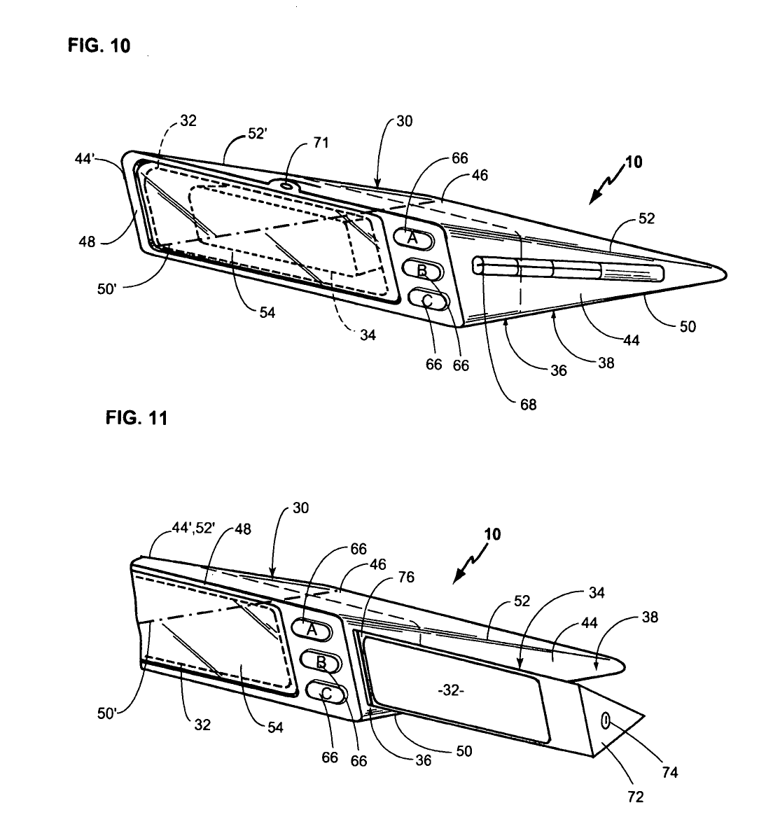

FIG. 10 illustrates one embodiment of the housing 30 formed with a credit card reader 68 for receiving one or more inputs from the spectator for completing a financial transaction. The credit card reader 68 may be formed along the side walls 44 and 44′ or top wall 48 of the housing 30 and is operatively connected to the computer unit 34. In the embodiment of the housing 30 shown in FIG. 10, the credit card reader 68 has been formed along the side wall 44 of the housing 30. The credit card reader 68 may be adaptable for allowing a spectator to provide their credit card information by swiping or sliding a credit card through the credit card reader 68. The computer unit 34 would then communicate the credit card information to a remote central processing unit 70 in order to perform a point-of-sale financial transaction or the like, as will be described with respect to the system 130. It should be understood by those skilled in the art that the credit card reader 68 may be adaptable for allowing a spectator to input their debit card, loyalty card or gift card information using the credit card reader 68 on the display apparatus 10 of the present invention.

FIG. 10 illustrates a further embodiment of the housing 30 formed with a camera aperture 71 for containing a camera (not shown) directed towards a spectator seated adjacent to the subject display apparatus 10. The camera is operatively connected to the computer unit 34 and may be actuated by a spectator using the one or more input buttons 66, for example, to take the spectator's photograph for posterity. The computer unit 34 may be adapted to receive the one or more inputs for photographs from the spectator and communicate the resulting photographs as one or more inputs to the remote central processing unit 70 referenced in FIG. 18. Upon receipt of the one or more inputs, the remote central processing unit 70 of FIG. 18 may display the one or more photographs on display apparatuses 10 throughout the entertainment or sporting venue or on a website associated with the entertainment or sporting venue, for example.

In an embodiment of the invention shown in FIGS. 3 and 11 the display screen 32 and the computer unit 34 may be slidably removed from and replaced within the interior space 40 of the housing 30 through an access panel 72 formed in one of the side walls 44 and 44′. The access panel 72 is constructed with a barrel lock 74 which is operable between a locked position and an unlocked position using a key, magnet or combination thereof (not shown). When unlocked, the access panel 72 may be removed from the side wall 44 of the housing 30 to provide access to the display screen 32 and the computer unit 34 through an access aperture 76. By this design, a malfunctioning display screen 32 and/or computer unit 34 may be removed through the access panel 72 and quickly replaced with a functioning display screen 32 and/or computer unit 34. The access panel 72 may then be aligned with the access aperture 76 and locked in positioned using the key.

The housing 30 is preferably formed using an injection molding process using high impact polystyrene or polypropylene. Although other fabrication methods and materials may be equally suitable as is known in the art. In order to minimize the visual impact of the display apparatus 10 mounted on the back surface 28 of the seating structure 16, the housing 30 may be fabricated from a material similar in appearance, color and texture to the material from which the back surface 28 is fabricated. While the display apparatus 10 is described herein as being manufactured and mounted in a seating structure 16 as an after-market product, it should be understood by those skilled in the art of the present invention that the display apparatus 10 may alternatively be mounted in the seating structure 16 at the factory where the seating structure 16 is manufactured and assembled. By this design, the display apparatus 10 may be molded directly into the back surface 28 of the seating structure 16, thereby saving considerable time in providing the display apparatus 10 throughout a sporting or entertainment venue and presenting an aesthetically pleasing seating structure 16 and display apparatus 10.

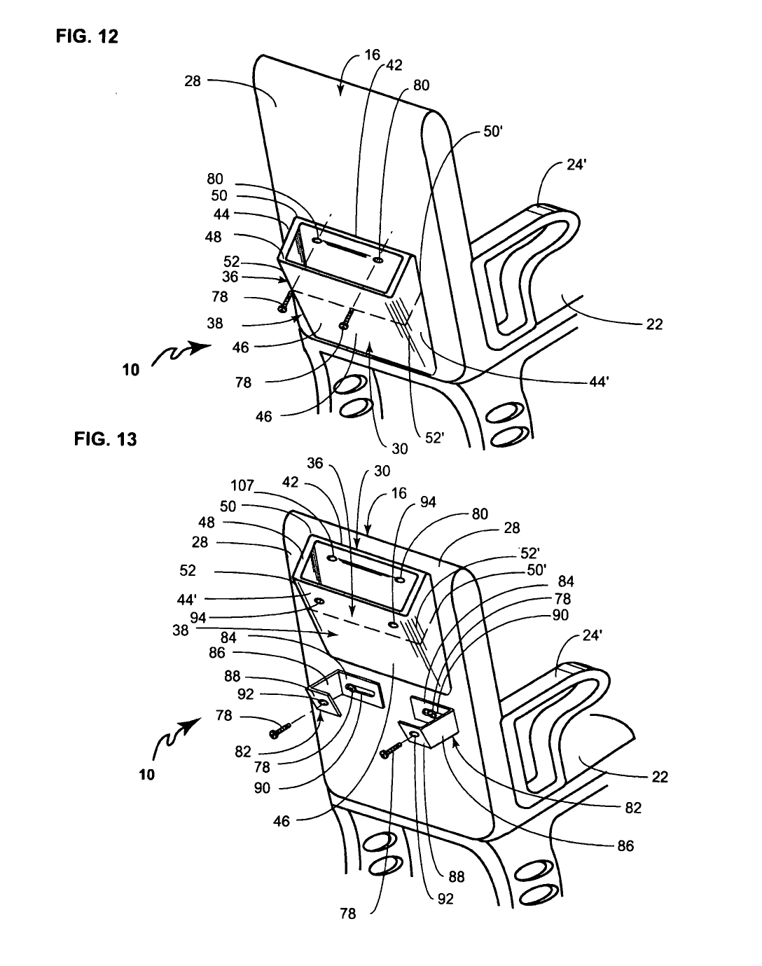

FIG. 12 illustrates the display apparatus 10 of the present invention mounted to the back surface 28 of the seating structure 16. The rear wall 42 of the housing 30 is adapted for mounting to the back surface 28 of the seating structure 16 using at least one fastener 78, such as a bolt, screw, weld, fitting, connection, coupling or any number of fasteners known to those of ordinary skill in the art. Each of the at least one fastener 78 may be inserted into one or more corresponding through-holes 80 in the rear wall 42 of the housing 30 and into the back surface 28 of the seating structure 16 to securely mount the housing 30 to the seating structure 16. Alternatively, it should be understood that the housing 30 may also be adaptable for mounting to the back surface 28 of the seating structure 16 using an adhesive material (not shown). The fastener 78 or adhesive material should have sufficient fastening or adhesive strength to support the weight of the display apparatus 10, as well as the weight of the spectator's feet and legs when the housing 30 is utilized as a footrest. In order to withstand acts of vandalism, the fastener 78 or adhesive material preferably possesses sufficient fastening or adhesive strength to withstand forceful impacts, such as, for example, kicks and punches.

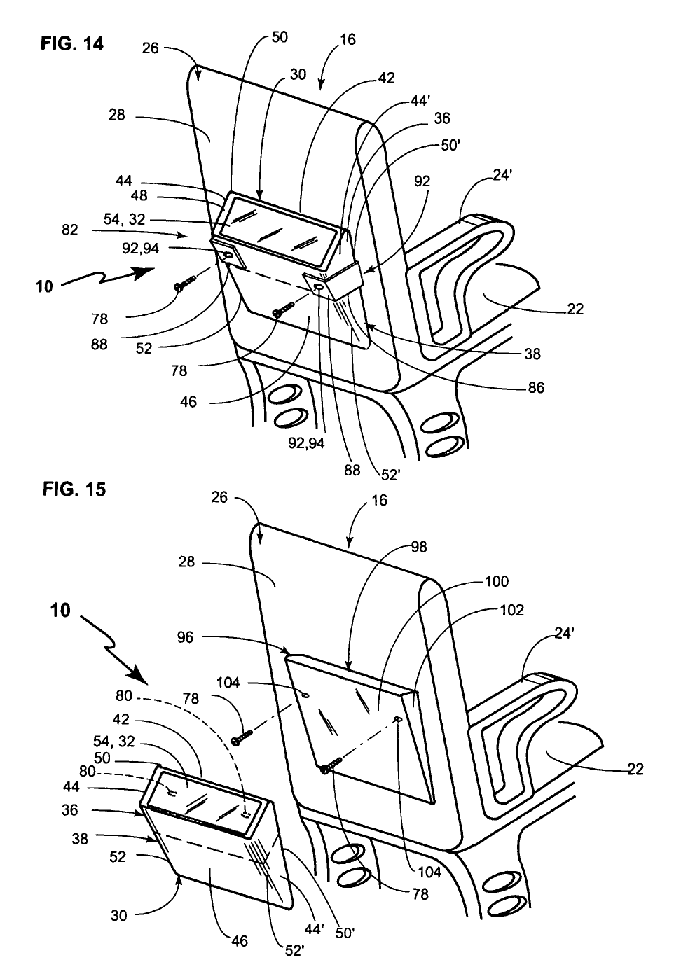

FIGS. 13 and 14 illustrate the display apparatus 10 mounted to the back surface 28 of the seating structure 16 using a pair of mounting brackets 82. Each of the mounting brackets 82 comprise a metal bracket having a back plate 84 for coupling to the back surface 28 of the seating structure 16, an integral side plate 86 extending rearwardly from the back plate 84 and an integral front plate 88 extending from the side plate 86. The front plate 88 is spaced apart from the back plate 84 a sufficient distance to receive the thickness of the housing 30 and to engage with the front wall 46 of the housing when the housing 30 is positioned within and between the pair of mounting brackets 82. The back plate 84 is formed with an elongated slot 90 that extends perpendicularly to the side plate 86 to permit the adjustable positioning of the mounting brackets 82 relative to the housing 30. The elongated slot 90 is dimensioned to receive any suitable fastener, such as the fastener 78, having sufficient strength characteristics and length to secure the back plate 84 of the mounting bracket 82 to the back surface 28 of the seating structure 16. The front plate 88 of each of the mounting brackets 82 is formed with a mounting aperture 92 adapted to register with a corresponding mounting aperture 94 in the front surface 46 of the housing 30. As shown in FIG. 14, when the housing 30 is positioned within and between the pair of mounting brackets 82 across the back surface 28 of the seating structure 16, each of the side plates 86 may be forced sideways towards each other as by tapping with a hammer or the like until the mounting apertures 92 on each of the front plates 88 register with the corresponding mounting apertures 94 on the housing 30. A suitable fastener, such as the fastener 78, may be inserted and secured within each of the mounting apertures 92 and the corresponding mounting apertures 94 to secure the housing 30 to the mounting bracket 82. It should be understood by those skilled in the art that any suitable fastener or mounting bracket may be utilized to securely mount the housing 30 of the display apparatus 10 to the back surface 28 of the seating structure 16.

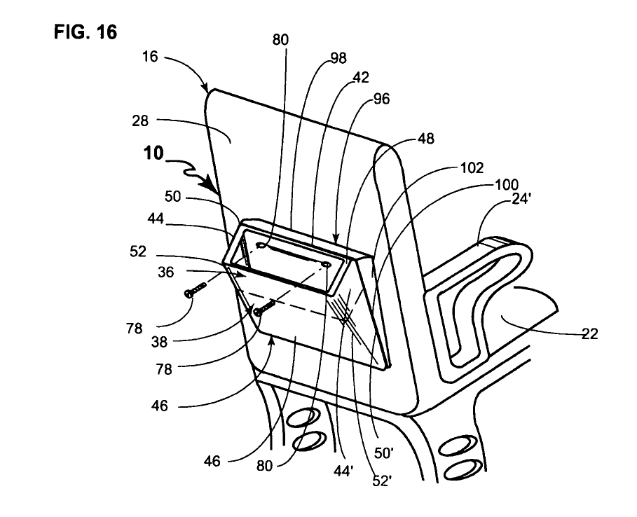

FIGS. 15 and 16 illustrate the display apparatus 10 of the present invention mounted to the back surface 28 of the seating structure 16 using a spacer 96. The spacer 96 includes a spacer body 98 having a mounting surface 100 and a pair of side surfaces 102. The mounting surface 100 of the spacer body 98 is adapted for mounting to the back surface 28 of the seating structure 16 using a suitable fastener, such as, for example, fastener 78. Each of the at least one fastener 78 may be inserted into one or more corresponding spacer holes 104 in the mounting surface 100 of the spacer body 98 and into the back surface 28 of the seating structure 16 to securely mount the spacer 96 to the seating structure 16. As shown in FIG. 16, the rear wall 42 of the housing 30 may then be positioned adjacent to the mounting surface 100 and secured to the spacer 96 using the one or more fasteners 78 inserted into the one or more corresponding through holes 80.

In use, the spacer 96 may be dimensioned to correspond to the shape and configuration of the back surface 28 of common manufactures of seating structures 16 to facilitate the quick installation of the display apparatus 10 of the present invention in sporting and entertainment venues. Depending upon the shape and configuration of the back surface 28 of the seating structure 16, the side surface 102 of the spacer 96 may have a generally triangular profile (as shown in FIG. 15). In addition to facilitating the quick installation of the display apparatus 10, the spacer 96 may be shaped and dimensioned for orientating the top wall 48 and display screen 32 at a readily viewable predetermined angle of inclination B′ (shown in FIGS. 5, 6 and 7) towards a spectator seated adjacent to the display apparatus 10. The spacer 96 may be formed using an injection molding process using high impact polystyrene or polypropylene, or any other fabrication methods and materials known by persons skilled in the art. In order to minimize the visual impact of the spacer 96 and the display apparatus 10 mounted on the back surface 28 of the seating structure 16, the spacer 96 may be fabricated from a material similar in appearance, color and texture to the material from which the back surface 28 and/or the housing 30 is fabricated.

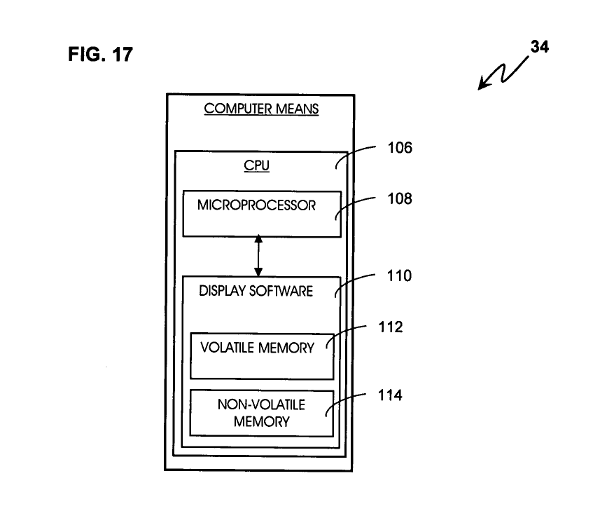

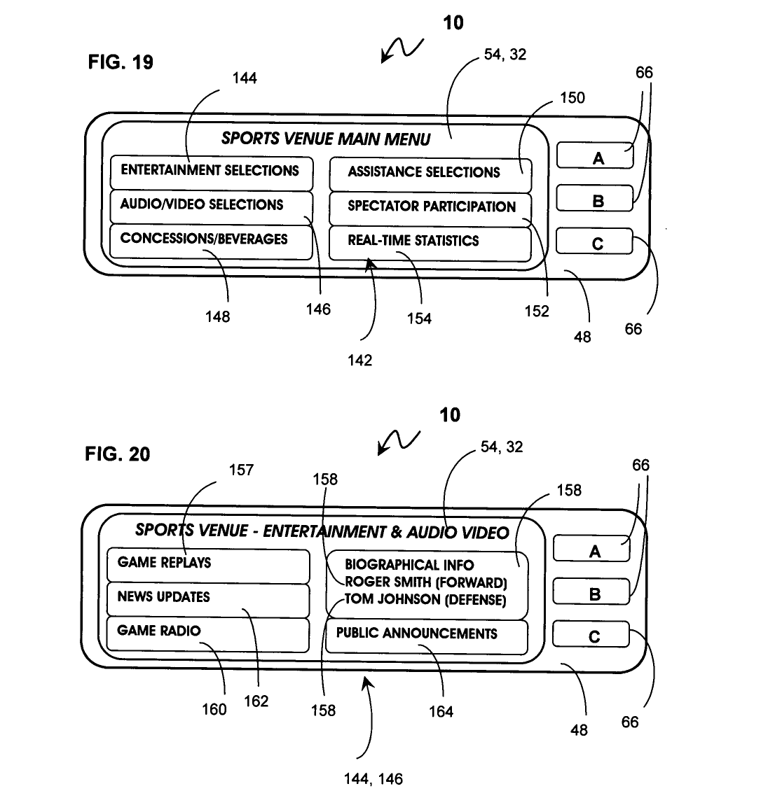

Referring to FIG. 17, the computer unit 34 is adapted to generate the one or more visual images for display to a spectator seated adjacent to and facing the display screen 32 of the present invention. The computer unit 34 comprises a central processing unit (CPU) 106 that contains electronics and software, and is powered by battery, power outlet or any other suitable power source. In one embodiment of the present invention, the CPU 106 contains a display microprocessor 108 and a display software 110 for generating the one or more visual images displayed on the display screen 32. The CPU 106 may consist of both a volatile memory 112, such as flash memory and/or random access memory (RAM), and a non-volatile memory 114, such as magnetic random access memory (MRAM), erasable programmable read-only memory (EPROM), and/or electronically erasable programmable read-only memory (EEPROM). The display software 110 is adaptable to contain computer program instructions for the display microprocessor 108 for use when generating the one or more visual images. The display software 110 may also store information for generating the one or more visual images, such as advertisements, promotional notices and the vital statistics of the participants in the sporting and entertainment event, for example. Referring to FIG. 18, the display microprocessor 108 may also be adapted for receiving one or more inputs from the spectators and communicating the one or more inputs to the remote central processing unit 70. The remote central processing unit 70 adaptable for analyzing the one or more inputs from the display microprocessor 108 of the computer unit 34 and generating one or more outputs for controlling the one or more visual images generated, displayed and/or stored by the computer unit 34. As will be discussed with reference to FIGS. 19-26, the one or more visual images generated and/or stored by the computer unit 34 and displayed on the display screen 32 may comprise of a wide variety of information of interest to spectators at a sporting or entertainment event, including concession and beverage selections, entertainment selections, and spectator participation selections, for example.

Reference will now be made to FIG. 18 which illustrates a display system 130 comprising of a plurality of display apparatuses 10 in accordance with a preferred embodiment of the present invention. The display system includes the one or more display apparatuses 10 which are mounted to seating structures 16 throughout the sporting or entertainment venue and the remote central processing unit 70 which is adapted to communicate with each of the one or more display apparatuses 10 via a two-way communication network 132. The central processing unit 70 is situated remotely from the one or more display apparatuses 10. The central processing unit 70 includes a transceiver 134 configured for transmitting the one or more visual images to the display microprocessors 84 of the one or more display apparatuses 10. The transceiver 134 is further configured for receiving the one or more inputs from the spectators using the touch panel display screen 32, input button functions or the credit card reader 68 of the one or more display apparatuses 10. The one or more inputs are gathered, analyzed and processed by the central processing unit 70. Based on the one or more inputs, the central processing unit 70 generates and transmits one or more outputs for controlling the one or more visual images displayed on the one or more display apparatuses 10. The one or more outputs may include additional advertisements and promotions that transmitted to each of the plurality of display apparatus for storing in the display microprocessor 84 of the computer unit 34 and for subsequently displaying to each of the spectators on the display screens 32. The central processing unit 70 may include an interface 136, such as a graphical user interface (GUI), and an operating system (OS) 138 that reside within machine readable media to control the operation of the display system. The interface 136 may be utilized by a venue operator for generating the one or more outputs from the display system and specifically controlling the nature of the entertainment, audio and video, concession and beverage, assistance, spectator participation selections and real-time statistics presented to spectators during the sporting or entertainment event. The one or more outputs may consist of computer software instructions, XML or HTML web pages or text documents that are readable by the display software 86 for controlling the one or more visual images generated and displayed on the display screens 32 of the one or more display apparatuses 10.

Any suitable two-way communication network 132 known by those skilled in the art may be utilized with the display system of the present invention, such as a wireless or wired network. A wireless communication network may comprise of a personal communication service (PCS) network, a satellite-based network or radio frequency-based network, or any other suitable wireless communication network known by those skilled in the art. A wired network may consist of lengths of cables, such as, for example, coaxial cable or fiber-optic cable, extending from the central processing unit 70 to each of the one or more display apparatuses 10. In order to minimize the costs associated with installing the display system of the present invention in existing sporting and entertainment venues, it may be most advantageous to utilize a wireless two-way communication network.

The display system may further comprise an external communication link 140 to enable the central processing unit 70 to communicate with an Internet network 142 and gather additional information necessary to generate the one or more outputs. For example, the external communication link 140 may be utilized by the central processing unit 70 to gather the real-time statistics associated with sporting events being held in other cities that may be of interest to spectators at the subject sporting or entertainment event. The central processing unit 70 may also utilize the external communication link 140 to gather news and weather updates for displaying to spectators within the venue.

The display system of the present invention is particularly well suited for generating and displaying one or more visual images in the form of advertisements and promotions to an audience of spectators. Traditionally, advertisements and promotions at sporting and entertainment events have been limited to venue signage, score board screens, occasional audio announcements made during intermissions or delays in the events. Venue operators may display a wide variety of advertisements and promotions to spectators throughout the duration of sporting or entertainment events, including car-related advertisements, concession and beverage advertisements, and up-coming event advertisements.

Referring to FIG. 19, the one or more visual images may provide a main menu 142 of one or more selections to a spectator selected from the class of entertainment selections 144, audio and video selections 146, concession and beverage selections 148, assistance selections 150, spectator participation selections 152, and real-time statistics 154. For example, the entertainment selections 144 may enable a spectator to view biographical information 156 relating to one or more participants 158 in the sporting or entertainment event, as well as one or more visual images showing career highlights. As shown in FIGS. 20 and 26, the entertainment selections 144 may also enable a spectator to view one or more visual images showing replays 159 of recent plays in a sporting event or scenes in an entertainment event. The audio and video selections 146 may be adaptable to enable a spectator using the touch screen display screen 32 or input buttons 66 overlying the display screen 32 to scroll through a menu of audio and video selections 146 and initiate a radio and music functions 160, news reports 162 and/or public service announcements 164, for example, that the spectator can listen to using headphones or earpieces while observing the sporting or entertainment event.

In an exemplary embodiment shown in FIG. 21, at any time during the sporting or entertainment event, spectators may order one or more concessions offered by the venue operator using a menu of concession and beverage selections 148 displayed in the one or more visual images on the display screen 32. To order a concession and beverage, the spectator touches or presses the touch screen display screen 32 or input buttons 66, respectively, corresponding to their selections on the display screen 32. The spectator may also opt to pay for the concession and beverage using a payment field 166 on the display screen 32 which communicates with the computer unit 34 to initiate the credit card reader 68.

The menu of concessions and beverage selections 148 may present a wide variety of fields to the spectator, including, but not limited to, a type field 157 identifying the types of concessions and beverages offered by the venue operator, a price field 168 with the price of the concessions and beverages, and a health and food information field 169. The health and food information field 169 may provide the spectator with dietary information concerning each of the concessions and beverages, such as whether one or more of the concessions and beverages are organically grown, prepared kosher and/or vegan friendly. The one or more inputs of concessions and beverages are gathered by the central processing unit 70 as shown in FIG. 18 and communicated to the venue operator or a kitchen (not shown) within the sporting or entertainment venue. Upon receiving the one or more inputs from the spectators, the venue operator or the kitchen staff can then prepare the concession beverage selections 148 and send the selections to the respective spectator by a waiter. While the spectator is waiting to receive the ordered concessions and/or beverages, they may continue to enjoy the activities of the sporting or entertainment event without the hassle of waiting in a line-up at the concession stand. Alternatively, the spectator may wish to participate in spectator participation selections 152 provided by the computer unit 34 and/or central processing unit 70 and involving a plurality of spectators situated throughout the sporting or entertainment venue.

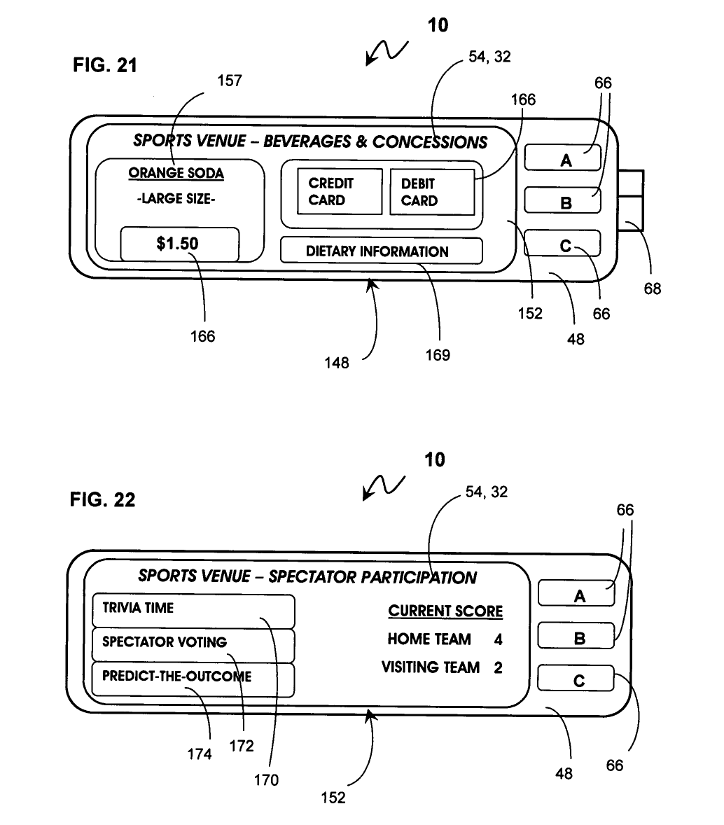

In a further exemplary embodiment of the present invention shown in FIG. 22, the one or more visual images may consist one or more interactive spectator participation selections 152, including sporting and/or entertainment trivia 170, and spectator voting 172 and prediction games 174. The computer unit 34 and/or central processing unit 70 may be adapted to generate and display one or more visual images consisting of random trivia questions to the spectator during intermissions in the sporting or entertainment event. Referring to FIG. 23, the one or more visual images corresponding to the entertainment trivia selection 170 may consist of a question field 176 in which a trivia question is posed to the spectator (e.g. “What team won the 1992 World Series of Baseball?”) and one or more answer fields 178 depending the nature of the trivia question set out in the question field 176. In the display screen 32 shown in FIG. 23, the spectator has the option of selecting “Boston Red Sox” in the first answer field 180, “Toronto Blue Jays” in the second answer field 182 and the “Chicago Cubs” in the third answer field 184. If the spectator selects the correct answer to the trivia question, the display apparatus 10 may be adapted to generate and display one or more visual images congratulating the spectator.

As shown in FIG. 24, the display screen 32 may display one or more visual images for prediction games 174 consisting of a prediction question field 185 and one or more prediction fields 186 that the spectator may utilize to input their predictions. In this example, the spectator has been presented with the question in a prediction event field 186 requesting the spectator's prediction as to whether they believe a hockey player will score a goal in a forthcoming penalty shot. The one or more visual images displayed on the display screen 32 provide a first prediction field 188 for the prediction “YES” and a second prediction field 190 for the prediction “NO”. By this design, spectators are provided with an entertaining means for indirectly participating in the outcome of the sporting event.

In a further exemplary embodiment shown in FIG. 25, the one or more visual images on the display screen 32 may be adapted to display one or more assistance selections 150 in the event that the spectator requires medical attention or the assistance of an usher. For such uses, the one or more visual images may include one or more assistance fields 192 enabling a spectator to specify whether they require “MEDICAL” assistance (e.g. the first assistance field 194) or “USHER” assistance (e.g. the second assistance field 196). It should be understood by those skilled in the art of the present invention that a wide variety of information may be displayed as one or more visual images on the display screen 32, and that the exemplary embodiments shown in FIGS. 19-26 are not intended to limit the scope of the present invention.

In use, the display apparatus 10 and system 130 of the present invention allow a venue operator to display a wide variety of information of interest to spectators seated in a sporting or entertainment venue. The information displayed on the one or more display apparatuses 10 is designed to enhance the spectators' enjoyment of the sporting or entertainment event through the provision of beverage and concession selections 148, entertainment selections 144 and spectator participation selections 152, for example. The display apparatus 10 and system 130 also allow a venue operator to realize potentially larger revenue from the sale of concessions and beverages during a sporting or entertainment event, as these offerings may be conveniently purchased by the spectators seated throughout the venue using the touch screen display screen 32 or input buttons 66 on the display apparatuses 10. Venue operators may also utilize the display apparatus 10 and system 130 of the present invention to display one or more visual images to initiate cheering, clapping and other forms of appreciation to enhance the atmosphere within the venue and the overall enjoyment of the spectators.

It will be appreciated that the specific embodiments illustrated and described herein are by way of example only, and are not to be construed as limiting the scope of the invention. The details of the appropriate mounting of the display apparatus 10 may differ from venue to venue according to the type of seating structures 16 and seating arrangements in use. Such mounting details do not depart from the scope of the present invention. In all cases, it is contemplated that a plurality of display apparatuses 10 may be provided in a sporting or entertainment venue, each securely mounted to the back surface 28 of a seating structure 16 with the display screen 32 disposed at predetermined angle of inclination so as to be readily viewable by a spectator seated adjacent to and facing each of the subject display apparatuses 10.

While what has been shown and described herein constitutes a preferred embodiment of the subject invention, it should be understood that various modifications and adaptations of such embodiment can be made without departing from the present invention, the scope of which is defined in the appended claims.

1. A display apparatus for mounting to a back surface of a seating structure, the display device comprising:
a housing formed with a rear wall for mounting to the back surface of the seating structure, a pair of side walls extending from the rear wall to a front wall, and a top wall formed with a transparent portion;
a display screen positioned interiorly of the housing adjacent to the top wall, the display screen displaying one or more visual images viewable through the transparent portion of the top wall of the housing; and
a computer unit positioned interiorly of the housing and operatively connected to the display screen for generating the one or more visual images.

2. The display apparatus as defined in claim 1, wherein the top wall and display screen are disposed at a predetermined angle of inclination to the horizontal.

3. The display apparatus as defined in claim 2, wherein the predetermined angle of inclination of the display screen directing the one or more visual images toward a spectator seated adjacent to the display apparatus.

4. The display apparatus as defined in claim 1, wherein the one or more visual images on the display screen of the display apparatus are directed upwardly to be readily viewable to a spectator in a seated position.

5. The display apparatus as defined in claim 1, wherein the housing includes a cover portion and a body portion coupled to the cover portion, the cover portion and the body portion defining the rear wall, the pair of side walls and the front wall, and the cover portion defining the top wall.

6. The display apparatus as defined in claim 5, wherein the coupling of the cover portion with the body portion forms an environmentally sealed interior space.

7. The display apparatus as defined in claim 5, wherein the cover portion is releasably coupled to the body portion using a lock means.

8. The display apparatus as defined in claim 1, wherein the transparent portion of the top wall of the housing is a transparent touch panel overlying the display screen for receiving one or more inputs when touched by a spectator.

9. The display apparatus as defined in claim 1, wherein the housing is formed with one or more input buttons for receiving one or more inputs when touched by a spectator.

10. The display apparatus as defined in claim 1, wherein the display screen comprising a touch panel for receiving one or more inputs when touched by a spectator.

11. The display apparatus as defined in claim 1, wherein the display screen is positioned beneath and coplanar to the transparent portion of the top wall of the housing.

12. The display apparatus as defined in claim 1, wherein the one or more visual images displayed on the display screen providing a menu of one or more selections offered to a spectator.

13. The display apparatus as defined in claim 1, wherein the one or more visual images provide a menu of one or more selections selected from the class of entertainment selections, promotional selections, audio and video selections, concession and beverage selections, assistance selections, spectator participation selections including interactive spectator trivia, voting and prediction selections, display of real-time statistics and information offered to a spectator.

14. The display apparatus as defined in claim 1, wherein the housing is mounted to the back surface of the seating structure using a pair of mounting brackets and at least one fastener.

15. The display apparatus as defined in claim 1, wherein the housing is coupled to a spacer for mounting the display apparatus to the back surface of the seating structure.

16. The display apparatus as defined in claim 15, wherein the mounting of the housing to the spacer maintains the display screen at a readily viewable predetermined angle of inclination.

17. The display apparatus as defined in claim 1, wherein the housing is fabricated from a material similar in appearance, color and texture to the material covering the back surface of the seating structure on which the display apparatus is mounted.

18. The display apparatus as defined in claim 11, wherein the top wall including a credit card reader operatively connected with the computer unit and adapted for allowing a spectator to input the spectator's credit card information for purchasing one or more of the selections

19. The display apparatus as defined in claim 11, wherein the housing including a debit card reader operatively connected with the computer unit and adapted for allowing a spectator to input the spectator's debit card information for purchasing one or more of the selections

20. The display apparatus as defined in claim 1, wherein the front wall, pair of side walls and top wall are adaptable for displaying promotional material thereon to a spectator.

21. The display apparatus as defined in claim 1, wherein the housing is dimensioned to fit across the back surface of the seating structure.

22. The display apparatus as defined in claim 1, wherein the rear wall joining each of the pair of side walls along a rounded rear corner.

23. The display apparatus as defined in claim 1, wherein the front wall joining each of the pair of side walls along a rounded front corner.

24. The display apparatus as defined in claim 1, further comprising a central processing unit for communicating the one or more visual images to the computer unit, wherein the central processing unit controlling the one or more visual images generated by the computer unit and displayed on the display screen.

25. An entertainment display system for spectators seated in a venue having a plurality of seating structures each with a back surface, the entertainment system comprising:
a computer network;
at least one display apparatus in communication with the computer network, the at least one display apparatus having a housing for mounting to the back surface of the seating structure, a display screen positioned interiorly of the housing and a computer unit positioned interiorly of the housing and operatively connected to the display screen for generating one or more visual images; and
a central processing unit in communication with the computer network for communicating the one or more visual images to the computer unit, the central processing unit controlling the one or more visual images generated by the computer unit and displayed on the display screen;

26. The entertainment display system as defined in claim 25, wherein each at least one display apparatus adaptable for receiving one or more inputs from a spectator and communicating the one or more inputs to the central processing unit.

27. The entertainment display system as defined in claim 26, wherein the central processing unit adaptable for analyzing the one or more inputs from each at least one display apparatus and generating one or more outputs for controlling the one or more visual images generated by the computers means of each at least one display apparatus.

28. The entertainment display system as defined in claim 25, wherein the housing comprising a rear wall for mounting to the back surface of the seating structure, a pair of side walls extending from the rear wall to a front wall, and a top wall formed with a transparent portion, and the display screen positioned interiorly of the housing and displaying the one or more visual images viewable through the transparent portion of the top wall of the housing.

29. The entertainment display system as defined in claim 28, wherein the top wall and display screen are disposed at a predetermined angle of inclination to the horizontal, the predetermined angle of inclination of the display screen directing the one or more visual images thereon towards a spectator seated adjacent to each at least one display apparatus.

30. The entertainment display system as defined in claim 25, wherein the one or more visual images generated by the computer unit and displayed on the display screen of each of the at least one display apparatus are directed upwardly to be readily viewable to a spectator in a seated position.

31. The entertainment display system as defined in claim 25, wherein the display screen displays one or more visual images generated by the computer unit, and wherein the one or more visual images provide a menu of one or more selections offered to a spectator.

32. The entertainment display system as defined in claim 25, wherein the one or more visual images provide a menu of one or more selections selected from the class of entertainment selections, audio and video selections, concession and beverage selections, assistance selections, spectator participation selections including interactive spectator trivia, voting and prediction selections, display of real-time statistics and information offered to a spectator.
